(19) United States
(12) Patent Application Publication
(10) Pub. No.: US 2014/0215526 A1
(43) Pub. Date: Jul. 31, 2014

(54) VIDEO DISPLAY APPARATUS, SERVER, AND VIDEO DISPLAY METHOD

(71) Applicant: Kabushiki Kaisha Toshiba, Tokyo (JP)

(72) Inventor: Katsuhiko Yokochi, Kokubunji-shi (JP)

(73) Assignee: Kabushiki Kaisha Toshiba, Tokyo (JP)

(21) Appl. No.: 14/013,381

(22) Filed: Aug. 29, 2013

Related U.S. Application Data
(63) Continuation of application No. PCT/JP2013/058623, filed on Mar. 25, 2013.

(30) Foreign Application Priority Data
Jan. 31, 2013 (JP) 2013-017902

(51) Int. Cl. H04N 21/482

(52) U.S. Cl. CPC H04N 21/4828
USPC 725/53

(57) ABSTRACT

According to one embodiment, a video display apparatus including, a registering module, a sending module, a receiving module, and a controller. The registering module configured to register a keyword. The sending module configured to send the keyword to a server. The receiving module configured to receive control information based on the keyword from the server. The controller controls a turning on power or switching channels or turning off power on the basis of the control information.

### CROSS-REFERENCE TO RELATED APPLICATIONS

This application is a Continuation application of PCT Application No. PCT/JP2013/058623, filed Mar. 25, 2013 and based upon and claiming the benefit of priority from Japanese Patent Application No. 2013-017902, filed Jan. 31, 2013, the entire contents of all of which are incorporated herein by reference.

### FIELD

Embodiments described herein relate generally to a video display apparatus, a server, and a video display method.

### BACKGROUND

Video display apparatuses have been designed for user preferences. For example, there has been known a receiver which can reduce the burden of program selecting even when the receiver is applied to digital satellite broadcasting and many programs are broadcasted by multiple channels.

There have been also known a video display apparatus, a video signal output apparatus, and a video display apparatus channel selection method which allow channels of images provided via broadcasting or a general-purpose network to be seamlessly selected by category for improvement in user convenience.

Activation methods of the video display apparatus have also been contrived. For example, an activation system and an activation method of a recorder/reproducer, a video display apparatus, and a device on a network are provided to enable stable activation of the recorder/reproducer and the video display apparatus in association with a device connected by a two-way communication interface.

Although there are more needs for a video display apparatus which controls power supply and channels on the basis of user preference information, no means for meeting such needs have been known.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a detailed configuration in an information recorder/reproducer according to an embodiment;

FIG. 2 shows an example of a system configuration of an information processor (server) according to the embodiment;

FIG. 3 shows an example of a general configuration of an apparatus (system) according to the embodiment;

FIG. 4 shows an example of the display of a screen for keyword input from a video display apparatus according to the embodiment;

FIG. 5 shows an example of host information managed by a keyword search server according to the embodiment;

FIG. 6A shows an example of a flowchart for search and registration processing at the server according to the embodiment;

FIG. 6B shows an example of a flowchart for the search and registration processing at the server according to the embodiment;

FIG. 6C shows an example of a flowchart for the search and registration processing at the server according to the embodiment;

FIG. 7 shows an example of a program list for use in processing in the server used according to the embodiment;

FIG. 8 shows an example of the flow of server processing that uses a control information report list and the information therein for each program according to the embodiment;

FIG. 9A shows an example of a flowchart for program viewing processing in the video display apparatus according to the embodiment;

FIG. 9B shows an example of a flowchart for the program viewing processing in the video display apparatus according to the embodiment;

FIG. 10A shows an example of the display of a screen for pop-up input from the video display apparatus according to the embodiment; and

FIG. 10B shows an example of the display of a screen for the pop-up input from the video display apparatus according to the embodiment.

### DETAILED DESCRIPTION

Various embodiments will be described hereinafter with reference to the accompanying drawings.

In general, according to one embodiment, a video display apparatus comprises: a registering module, a sending module, a receiving module, and a controller. The registering module configured to register a keyword. The sending module configured to send the keyword to a server. The receiving module configured to receive control information based on the keyword from the server. The controller controls a turning on power or switching channels or turning off power on the basis of the control information.

Hereinafter, one embodiment will be described with reference to the drawings.

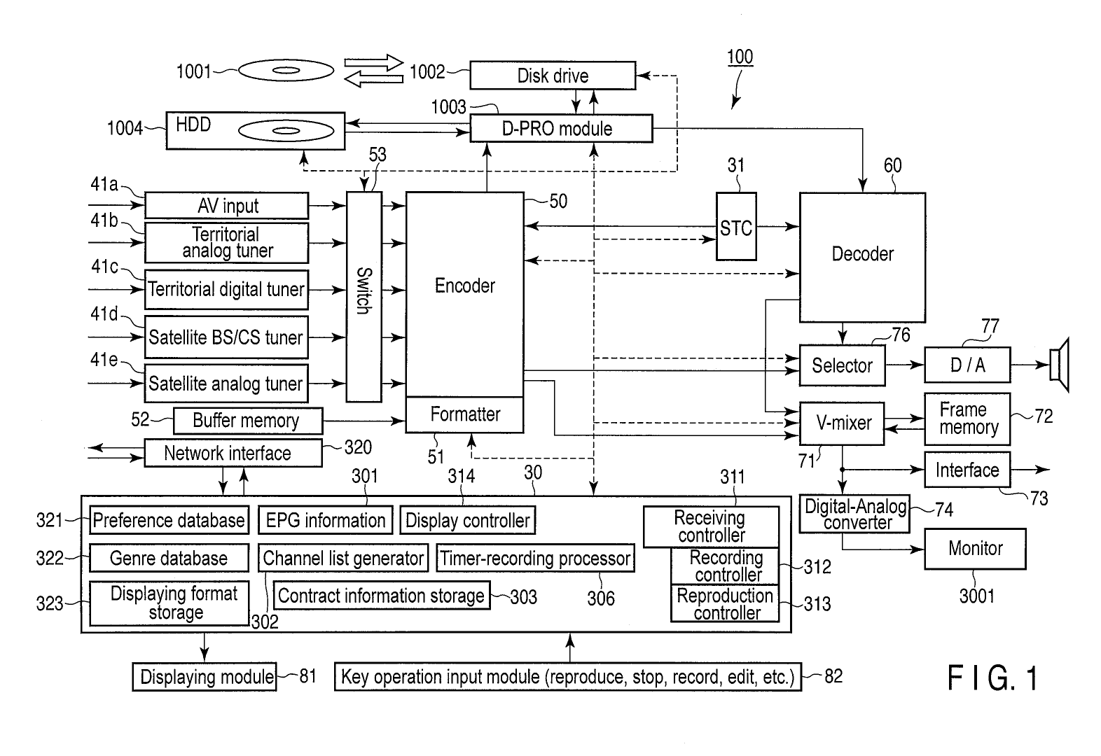

FIG. 1 is a block configuration diagram of an information recorder/reproducer (electronic apparatus/television receiver) 100 according to one embodiment of an electronic apparatus such as a video display apparatus (video receiver) of the embodiment.

The information recorder/reproducer 100 in FIG. 1 is shown as an apparatus capable of handling, as recording media, both an optical disk such as a DVD and a hard disk. However, the hard disk or an optical disk such as a DVD may be replaced by, for example, semiconductor memory recording medium. In FIG. 1, blocks are roughly classified into the main blocks of a recorder shown in the center and on the upper left side, and the main blocks of a reproducer shown on the right side.

The information recorder/reproducer 100 in FIG. 1 has two kinds of disk drives: a disk drive 1002 and a hard disk drive 1004. The disk drive 1002 rotationally drives an optical disk 1001, and reads and writes information. The disk drive 1002 has a rotational control system, a laser drive system, and an optical system for the optical disk 1001. The hard disk drive 1004 drives the hard disk.

A data processor (D-PRO module) 1003 can supply recording data to the disk drive 1002 and the hard disk drive 1004, and receive reproduced signals. The data processor 1003 handles data per recording or reproduction, and includes a buffer circuit, a modulation/demodulation circuit, and an error corrector.

The main components of the information recorder/reproducer 100 are an encoder section 50 which constitutes a recording side, a decoder section 60 which constitutes a reproduction side, and a microcomputer block 30 which controls the operation of the main part of the apparatus. The encoder section 50 includes a transport stream processor and a plurality of encoders.

The encoder section 50 has a video and audio analog/digital converter which basically digitizes input analog video signals and analog audio signals, a video encoder, and an audio encoder. The encoder section 50 further includes an auxiliary video encoder.

An encoded output from the encoder section 50 is converted to a predetermined DVD format by a formatter 51 including a buffer memory 52, and supplied to the aforementioned data processor 1003.

A packet elementary stream extracted from a transport stream may be directly recorded in the hard disk of the hard disk drive 1004 from the encoder section 50.

An external analog video signal and an external analog audio signal from an AV input 41a can be input to the encoder section 50 via a switch 53. Received signals from a territorial analog tuner 41b, a territorial digital tuner 41c, a satellite BS/CS tuner 41d, and a satellite analog tuner 41e can also be selectively input to the encoder section 50.

When a plurality of decoders are utilized in the encoder section 50, a program received by the territorial digital tuner 41c is recorded in the hard disk drive 1004, and at the same time, a program received by the satellite BS/CS tuner 41d can be viewed.

When a digital video signal and a digital audio signal that are compressed are directly input, the encoder section 50 can directly supply the compressed digital video signal and digital audio signal to the formatter 51. The encoder section 50 can also directly supply the analog-to-digital-converted digital video signal and audio signal to a video (V) mixer 71 and an audio selector 76.

An MPEG video encoder included in the encoder section 50 converts the digital video signal to a digital video signal compressed at a variable bit rate based on an MPEG2 or MPEG1 standard.

The digital audio signal is converted to a digital audio signal compressed at a fixed bit rate based on an MPEG or AC-3 standard or to a linear PCM digital audio signal.

When an auxiliary video signal is input from the AV input 41a (e.g. a signal from a DVD video player equipped with an independent output terminal for the auxiliary video signal), or when a DVD video signal having such a data configuration is broadcasted and received by one of TV tuners 41b to 41e, the auxiliary video signal in the DVD video signal is encoded (run-length-encoded) into an auxiliary video bit map by an auxiliary video encoder.

The encoded digital video signal, digital audio signal, and auxiliary video data are packed into a video pack, an audio pack, and an auxiliary video pack by the formatter 51. These packs are further collected, and then converted to a format (DVD-Video format) prescribed by a DVD-video standard or a format (DVD-VR format) prescribed by a DVD-recording standard. The formatter 51 also uses the buffer memory 52 during the above conversion processing.

In the information recorder/reproducer 100, the information (the packs of the video, audio, and auxiliary video data) formatted by the formatter 51 and created management information can be supplied to the hard disk drive 1004 or the disk drive 1002 via the data processor 1003, and recorded in the hard disk or the optical disk 1001.

The information recorded in the hard disk or the optical disk 1001 can be recorded in the optical disk 1001 or the hard disk via the data processor 1003 or the disk drive 1002.

Furthermore, video objects of a plurality of programs recorded in the hard disk or the optical disk 1001 can be edited, for example, partly deleted or combined with objects of different programs.

The microcomputer block 30 includes a micro processing unit (MPU) or a central processing unit (CPU), a ROM in which a control program and others are written, and a RAM for providing a work area necessary for program execution.

The microcomputer block 30 can be connected to an external network via a network interface (hereinafter, I/F) 320. This allows later-described channel list setting information to be loaded from an external server 10.

Furthermore, the MPU of the microcomputer block 30 uses the RAM as the work area for, for example, defective part detection, unrecorded area detection, recording-information record position setting, UDF recording, and AV address setting, in accordance with the control program stored in the ROM.

The micro computer block 30 has information processing section necessary for the overall control of the blocks of the apparatus, and comprises, for example, a work RAM, a directory detector, a VGM (overall video management information) information creator, a packet header processor, and a sequence header processor. The micro computer block 30 also comprises a management information controller for recording and a management information controller for editing.

As previously described, the microcomputer block 30 further has an EPG information processor 301, a channel list generator 302, and a contract information storage 303. As a graphic user interface for the operation of these components, the microcomputer block 30 also has a display controller 314. The microcomputer block 30 also has a receiving controller 311 which controls the tuners and others in accordance with timer-recording information, a recording controller 312 for program recording, and a reproduction controller 313 for recorded program reproduction.

As storages for attribute information and others for later-described channel list display, the microcomputer block 30 further has a preference database 321, a Genre database 322, and a displaying format storage 323.

Contents of execution results in the MPU to be reported to a user are displayed on a displaying module 81 of the information recorder/reproducer 100 or on-screen-displayed (OSD) on a monitor 3001.

The microcomputer block 30 also has a key operation input module 82 which supplies operation signals for operating this apparatus. The key operation input module 82 corresponds to, for example, operation switches provided on the body of the information recorder/reproducer 100, or a remote controller. The key operation input module 82 may be a personal computer connected to the recorder/reproducer by means such as wired communication, wireless communication, optical communication, or infrared communication. In any case, the user can operate the key operation input module 82 for recording processing of input video/audio signals, reproduction processing of recorded contents, or editing processing of recorded contents.

The microcomputer block 30 can control the disk drive 1002, the hard disk drive 1004, the data processor 1003, and the encoder section 50 and/or decoder section 60 by the timing based on time data from a system time clock (STC) 31. The recording or reproduction operation is normally performed synchronously with a time clock from the STC 31. However, other processing may be performed by timings independent of the STC 31.

The decoder section 60 has a separator which separates and takes each pack from the DVD-format signal having a pack structure, a memory for use in the pack separation and in the execution of other signal processing, a V-decoder which decodes the main video data (contents of the video pack) separated by the separator, an SP-decoder which decodes the auxiliary video data (contents of the auxiliary video pack) separated by the separator, and an A-decoder which decodes the audio data (contents of the audio pack) separated by the separator.

The decoder section 60 is also equipped with a video processor. The video processor properly composes a decoded auxiliary image with a decoded main image, and outputs the main image on which a menu, a highlight button, a caption, and other auxiliary images are superimposed.

A video signal output from the decoder section 60 is input to the video mixer 71. The video mixer 71 composes, for example, text data. A line which directly brings in signals from the TV tuners 41b to 41e and the AV input 41a is also connected to the video mixer 71.

A frame memory 72 used as a buffer is connected to the video mixer 71. When the output of the video mixer 71 is an analog output, this output is externally output via an interface (I/F) 73. When the output of the video mixer 71 is a digital output, this output is externally output via a digital/analog converter 74.

An audio signal output from the decoder section 60 is analog-converted by a digital/analog (D/A) converter 77 via the selector 76, and externally output. The selector 76 is controlled by a select signal from the microcomputer block 30. Thus, the selector 76 can directly select a signal passed through the encoder section 50 when the digital signals from the TV tuners 41b to 41e and the AV input 41a are directly monitored.

The formatter of the encoder section 50 creates cutting information during recording, and periodically sends the cutting information to the MPU of the microcomputer block 30 (information for, e.g., GOP head interrupt). The cutting information includes, for example, the number of packs of VOBU, an end address of an I-picture from the VOBU head, and a reproduction time of the VOBU.

At the same time, information from an aspect information processor is sent to the MPU at the start of recording, and the MPU creates VOB stream information (STI). Here, the STI saves resolution data and aspect data. In accordance with this information, each decoder section performs initial setting in reproduction.

In this apparatus, a minimum continuous information unit (size) is determined so that seamless reproduction is continued during data access (seeking). This unit is referred to as a contiguous data area (CDA). The CDA size is a multiple of an error correcting code (ECC) block (16 sectors). A file system performs recording by the CDA unit.

The data processor 1003 receives VOBU-unit data from the formatter of the encoder section 50, and supplies CDA-unit data to the disk drive 1002 or the hard disk drive 1004.

The MPU of the microcomputer block 30 creates management information necessary for the reproduction of recorded data, and sends the created management information to the data processor 1003 when recognizing a command to end data recording. As a result, the management information is recorded in the disk. Therefore, during encoding, the MPU of the microcomputer block 30 receives data-unit information (e.g. cutting information) from the encoder section 50.

The MPU of the microcomputer block 30 recognizes the management information (file system) read from the optical disk 1001 and the hard disk at the start of recording, recognizes unrecorded areas in each disk, and sets a data recording area in the disk from the data processor 1003.

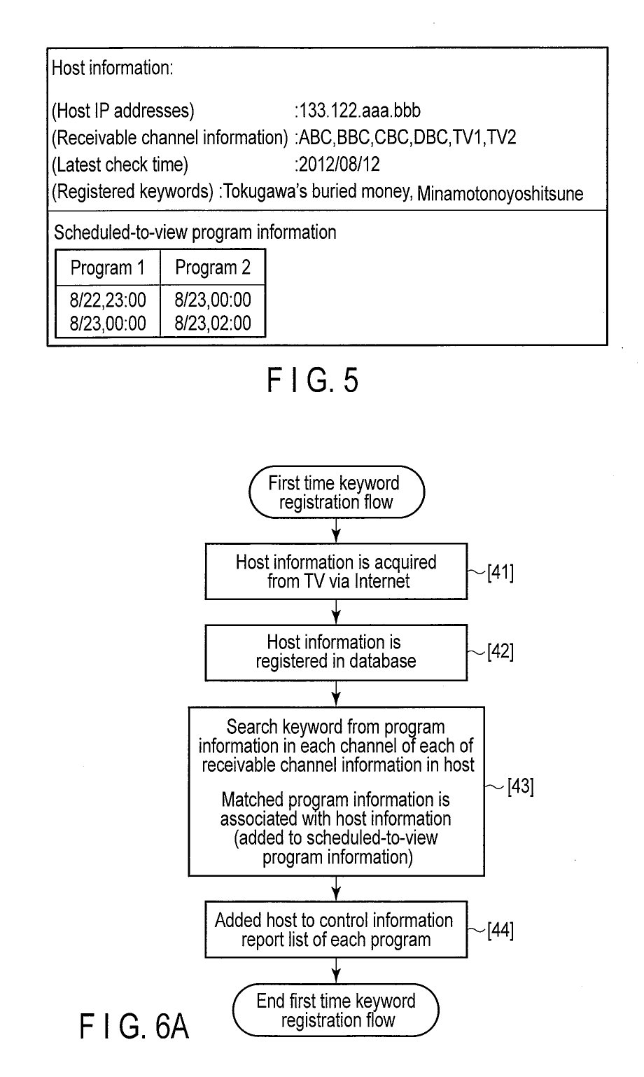

When the user registers a keyword or a classification as in FIG. 4 described later, information corresponding to the classification is stored in the preference database 321 or the Genre database 322 of the micro computer block 30 as needed.

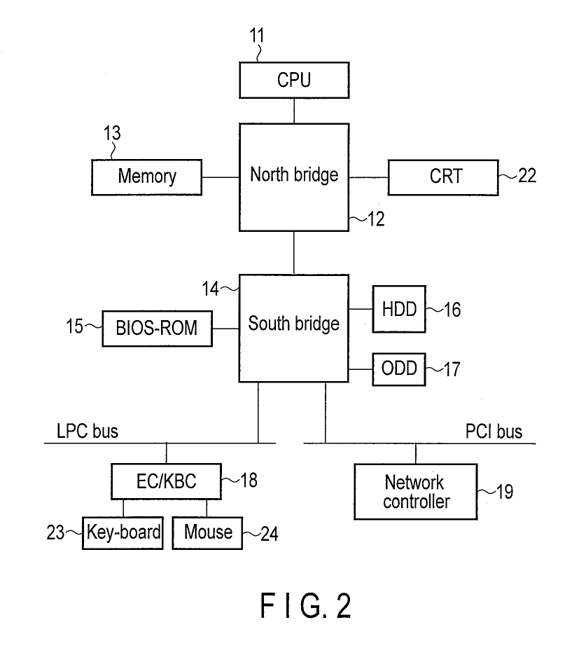

Meanwhile, FIG. 2 shows an example of a system configuration of the hardware of the (information) server 10 which relays a later-described network.

As shown in FIG. 2, the server 10 includes, for example, a CPU 11, a north bridge 12, a main memory 13, a south bridge 14, a BIOS-ROM 15, a magnetic disk drive (HDD) 16, a magneto-optical disk drive (ODD) 17, an embedded controller/keyboard controller IC (EC/KBC) 18, and a network controller 19.

The CPU 11 is a main processor which controls the operation of the server 10. The CPU 11 executes an operating system and various application programs and utility programs which are loaded to the main memory 13 from the HDD 16.

The north bridge 12 is a bridge device which connects a local bus of the CPU 11 to the south bridge 14. The north bridge 12 has therein a display controller which controls a CRT display 2, and a memory controller which controls the main memory 13.

The south bridge 14 functions as an I/O controller for controlling various I/O devices connected to, for example, a peripheral component interconnect (PCI) bus and a low pin count (LPC) bus. The south bridge 14 also has therein an integrated drive electronics (IDE) for controlling the HDD 16 and the ODD 17. The access to the BIOS-ROM 15 is also controlled by the south bridge 14. The BIOS-ROM 15 is a flash ROM for electrically rewritably storing a system BIOS.

The EC/KBC 18 is a one-chip microcomputer in which an embedded controller for power management and a keyboard controller for controlling a key-board (KB) 23 and a mouse 24 are integrated. The network controller 19 controls data communication with other computers via a LAN.

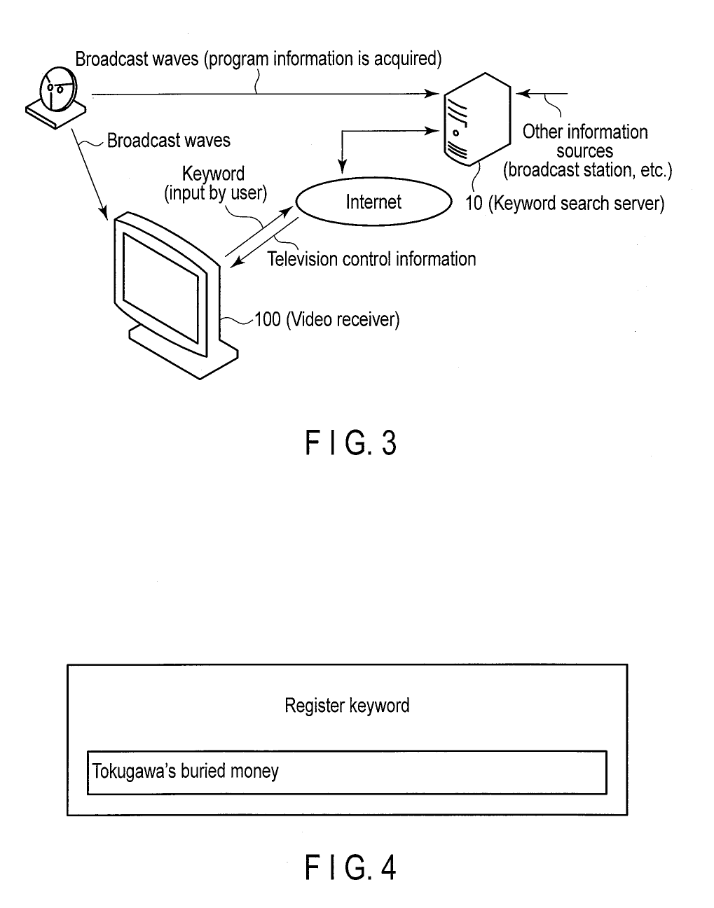

Now, a system shown in FIG. 3 can be constructed on the basis of the hardware configuration example described above. That is, FIG. 3 is a functional block configuration diagram showing one embodiment.

FIG. 3 is a configuration diagram in which the video display apparatus (information recorder/reproducer 100) is directly connected to the Internet. The information recorder/reproducer 100 is connected to the server 10 via an Internet 1. In the shown configuration, a channel list database provided by a channel list setting information provider such as the manufacturer of the information recorder/reproducer 100 in the server 10 is accessed via the Internet 1.

FIG. 3 is a schematic configuration diagram showing the apparatus (system) according to the embodiment. As will be described below in detail, the video display apparatus registers host information and a search keyword in the server 10, and the server 10 sends control information to a registration host in accordance with a program information result. The video display apparatus (TV apparatus) 100 shown in FIG. 3 sends an IP address of this video display apparatus and a registered keyword to keyword search server 10 via the Internet. The server 10 holds the information, that is, registered keyword sent by the video display apparatus. When program information on broadcast waves is changed (updated), the server 10 matches an updated part to the registered keyword, and prepares for the sending of control information for a matching program. Immediately before the start of the program (e.g. five minutes ahead), the server 10 sends the control information to the video receiver 100 so that the program can be viewed without the operation by the user.

FIG. 4 is a diagram showing a screen for keyword input from the video display apparatus. That is, this screen permits keyword input. In the situation shown, words “Tokugawa's buried money” are input in response to a prompt indication “Register keyword”.

The prompt is displayed on, for example, the displaying module 81, and the user can input a keyword from the key operation input module 82.

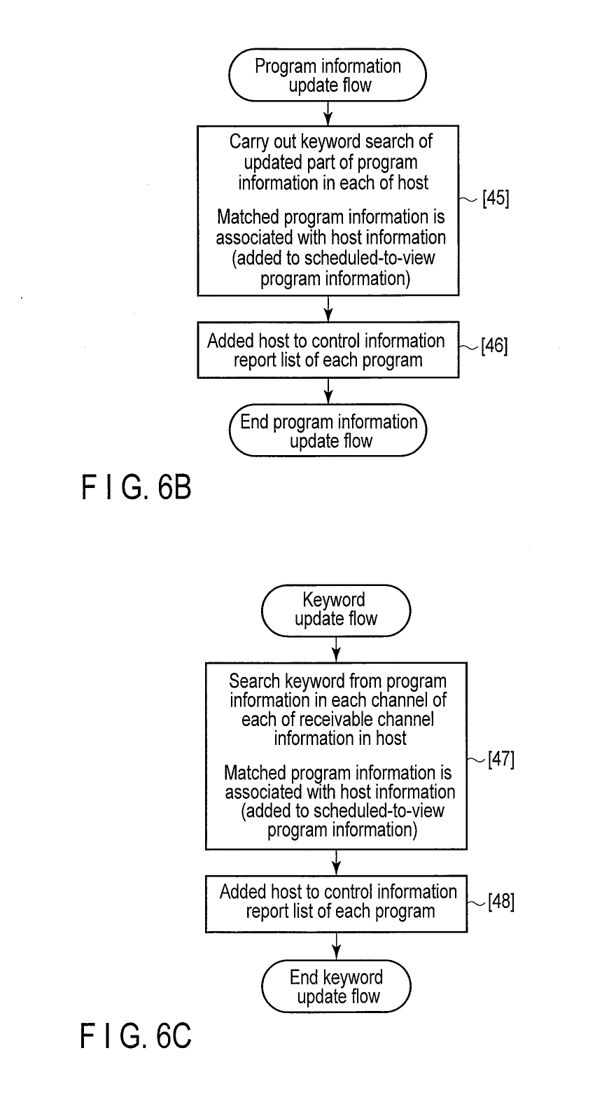

FIG. 5 is a diagram illustrating host information managed by the server 10 (hereinafter, keyword search server 10). For example, an IP address of a control information destination, receivable channel information, registered keywords, and information regarding programs currently scheduled to view are managed. The host information is placed in the HDD 16, and can be read and changed by the CPU 11.

Each TV set (host) can be identified from the keyword search server 10 by information regarding a product number (product serial number) of the TV set or if the TV set receives a fixed IP address option service (connection is always permitted by the same IP address, i.e., a fixed IP address/global IPv4 address) provided by an Internet provider. FIG. 5 illustrates first of all values (host IP addresses) 133, 122, aaa, and bbb as host information.

The following information is (receivable channel information) ABC, BBC, CBC, DBC, TV1, and TV2. For example, there are a channel set ★BC and a channel set TV★ in the illustrated case (each ★ is the variation in the set).

A (latest check time (date)) indicates the last check date when the host information is obtained. As the (registered keywords), “Minamotonoyoshitsune” is registered in addition to “Tokugawa's buried money” registered as shown in FIG. 4.

As next information regarding programs scheduled to view, information regarding a program 1 and information regarding a program 2 are saved in the host (host 1) (including unshown channel information). How to use such information is described below with the following flowchart.

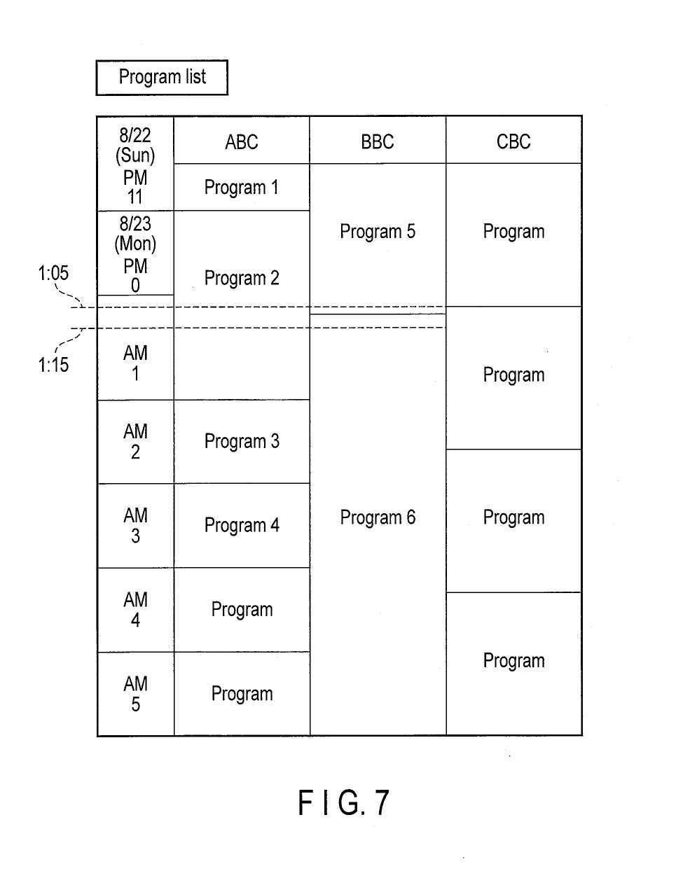

FIG. 6A, FIG. 6B, and FIG. 6C are flowcharts for search and registration processing mainly performed by the CPU 11 at the server.

During initial keyword registration (FIG. 6A: first time keyword registration flow), an IP address at the TV and the receivable channel information are registered in the server. Other processing is the same as processing shown in a keyword update flow shown in FIG. 6C, and program information and a keyword are searched for. That is, information regarding the matching program is added to scheduled-to-view program information in each host information. Host information is added to a control information report list of each program. When program information is each broadcast station is updated (FIG. 6B: program information update flow), the updated part is searched for the keyword in each host, and the keyword is added to the scheduled-to-view program information. The host information is added to the control information report list of each program.

Block 41: Host information (the IP address at the TV and the receivable channel information) is acquired from the TV via the Internet.

Block 42: The host information is registered in the database.

Block 43: search keyword from program information in each channel is searched for a keyword for each receivable channel information in the host. The matched program information is associated with the host information (added to the scheduled-to-view program information).

Block 44: This host is added to the control information report list of each program.

Block 45: The carry out keyword search of updated part of the program information is searched for the keyword in each host. The matched program information is associated with the host information (added to the scheduled-to-view program information).

Block 46: This host is added to the control information report list of each program.

Block 47: Search keyword from program information in each channel is searched for a keyword for each receivable channel information in the host. The matched program information is associated with the host information (added to the scheduled-to-view program information).

Block 48: This host is added to the control information report list of each program.

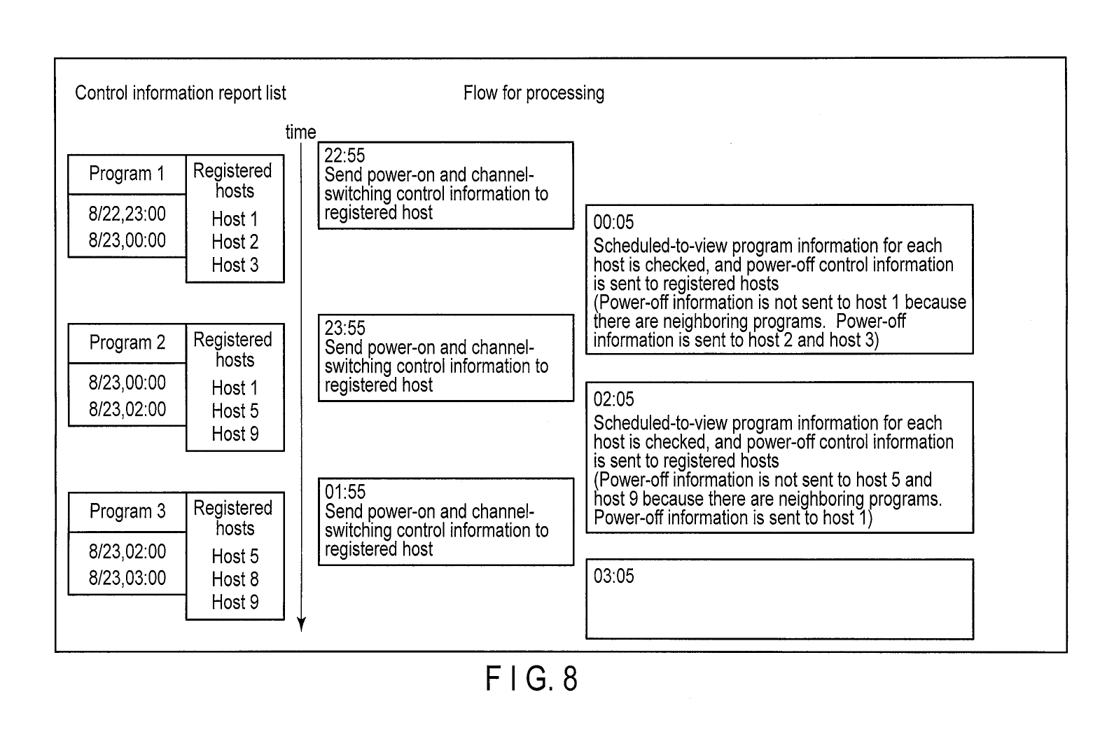

FIG. 7 is a diagram showing a program list used to explain the processing mainly performed by the CPU 11 in the server used in the embodiment. Each program has a description that introduces the contents of this program, and this description is targeted for the keyword search.

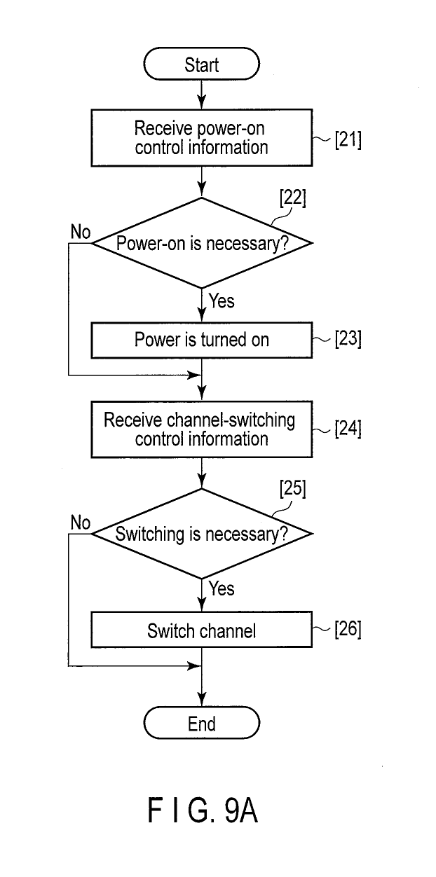

Although details will be described with reference to FIG. 8, programs 1 to 4 are selected as processing targets. The program 1 starts at 11 p.m. on August 22 (Sunday) in a channel ABC. The program 4 starts at 3 a.m. on August 23 (Monday).

FIG. 8 is a flowchart of server-led processing to be followed by the microcomputer block 30 which is mainly performed by the CPU 11 using the control information report list and the information therein for each program.

The server sends power-on information to the registered host (TV) several minutes before a prescribed time. When a power-off signal is sent, the scheduled-to-view program information in registered host information is checked before sending, and whether there is further television viewing are checked. Power-off control information is sent only when there is no further television viewing. That is, the server sends power-on and channel-switching control information to the registered host (TV) several minutes before the start of each program in each broadcast station. The server also searches program information in the registered host information several minutes before the end of each program in each broadcast station. The power-off control information is sent when there is no further program to view.

In the example of FIG. 8, first, in accordance with the control information report list, power-on and channel-switching control information is sent to the hosts 1 to 3 as registered hosts five minutes before start regarding the program 1 which starts at 11 p.m. on August 22 (Sunday) and ends at midnight on August 23 (Monday).

The scheduled-to-view program information for each host is checked five minutes after the end of the program 1, and the power-off control information is sent to the registered hosts. (However, the power-off control information is not sent to the host 1 because there are neighboring programs.)

Then regarding the program 2 which starts at midnight on August 23 (Monday) and ends at 2 a.m. on the same date, power-on and channel-switching control information is sent to the host 1, the host 5, and the host 9 as registered hosts five minutes before start in accordance with the control information report list. In the meantime, the host 1 has already been powered on and switched channels and therefore does not need to be changed in state. The time may be several minutes or zero minutes instead of five minutes. The user may be able to set a time length.

The scheduled-to-view program information in each host is checked five minutes before the end of the program 2, and the power-off control information is sent to registered hosts. (However, the power-off control information is not sent to the host 5 and the host 9 because there are neighboring programs.)

Then regarding the program 3 which starts at 2 a.m. on August 23 (Monday) and ends at 3 a.m. on the same date, power-on and channel-switching control information is sent to the host 5, the host 8, and the host 9 as registered hosts five minutes before start in accordance with the control information report list. The rest is similar and is therefore not described. The server may also acquire information from any source other than the broadcast waves, and keyword matching target information may be increased.

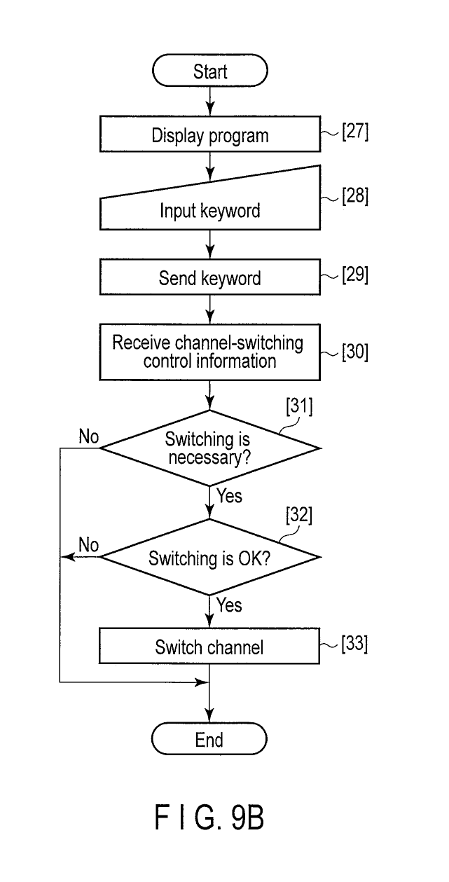

FIG. 9A and FIG. 9B are flowcharts for program viewing processing in the video display apparatus (TV) according to the embodiment.

FIG. 9A shows host processing corresponding to the flowchart for server processing in FIG. 8.

Block 21: The microcomputer block 30 (hereinafter, controller) receives the power-on control information from the server via the network interface 320.

Block 22: The host (information recorder/reproducer 100) needs to be powered on if powered off, and the processing moves to the next block accordingly. If the host is already powered on, the processing moves to block 24.

Block 23: The host is powered on.

Block 24: The controller receives the channel-switching control information from the server via the I/F.

Block 25: The processing moves to the next block if the channels need to be switched. The processing is finished if the channel corresponding to this control information is already set.

Block 26: The controller causes the territorial digital tuner 41c and the satellite BS/CS tuner 41d to tune into and switch to the channel corresponding to this control information, and the processing is finished.

FIG. 9B shows the processing in the host associated with the keyword input by the user.

Block 27: A program is being displayed. In one case, the current channel is reproduced by a resume function during the power-off of the host. In another case, a desired channel is set as a result of a tuning operation by the user.

Block 28: The user uses the key operation input module 82 to input a desired keyword as shown in FIG. 4 watching a screen on the monitor 3001.

Block 29: The controller sends this keyword to the server via the inter face. The processing normally ends here. However, the processing steps to a next step, if the keyword requires channel switching in association with the broadcasted program. For example, while the program 2 of the ABC channel is being broadcasted in FIG. 7, the channel is switched to the BBC channel which broadcasts a program 6.

Block 30: The controller receives the channel-switching control information from the server via the inter face.

Block 31: The processing moves to the next if channel switching is required. The processing is finished if the channel corresponding to this control information is already set.

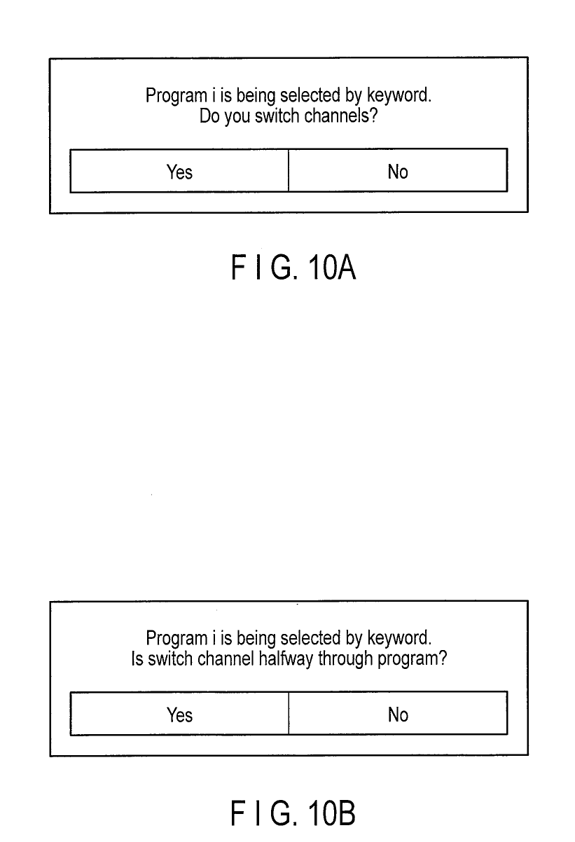

Block 32: The controller displays a pop-up display shown in FIG. 10A or FIG. 10B on the screen of the monitor 3001, and prompts the user to use the key operation input module 82 to switch channels. The program 6 starts at 1:10. Thus, if the start position of the channel switching is 1:05, the pop-up display shown in FIG. 10A can be displayed. If the start position is 1:15, the pop-up display with a message “halfway through program” shown in FIG. 10B can be displayed. The processing moves to the next if channel switching is selected. The processing is finished if channel switching is not selected. The pop-up displays may be set to disappear after a given length of time. Then the user may be allowed to previously set whether to automatically select channel switching. In this case, the pop-up display may be turned off.

Block 33: The controller causes the territorial digital tuner 41c and the satellite BS/CS tuner 41d to tune into and switch to the channel corresponding to this control information, and the processing is finished.

### Other Embodiments/Modifications

In the schematic configuration diagram showing the apparatus (system) according to the embodiment in FIG. 3, it is preferable to use a secure technique for the sending of the host information and the receiving of the control information in order to prevent, for example, impersonation by other hosts. (E.g., in order to prevent arbitrary registration of the keyword of a TV, it is ensured that the host information and the keyword are registered from this TV. It is also ensured that the TV only accepts the control information from the search server.)

The screen for keyword input from the video display apparatus shown in FIG. 4 may prompt the user to acquire, for example, a popular search keyword from the search server and then display and simply input the search keyword. Although not particularly shown, a plurality of keywords may be registered. When a plurality of keywords is registered, the keywords may be prioritized. Otherwise, AND conditions and OR conditions of the keywords may be set.

In the flow of the server processing that uses the control information report list and the information therein for each program shown in FIG. 8, power-off avoidance means may be provided so that when the power-off signal is received, for example, an indication “Power is turned off soon. Press OK button to keep watching.” is shown to the user. When, for example, the next program starts in five minutes, this program may be recognized as a neighboring program, so that the power is not turned off, and, for example, an indication “Next program starts soon and is made available without power-off.” may be shown.

Otherwise, the following configuration and method can be used when broadcast times of programs in the scheduled-to-view program information overlap.

(1) The user may be allowed to select which program to view.

As a user interface, for example, a list of programs may be displayed on the screen, and the user may select a program by, for example, the remote controller.

(2) A program to be viewed may be determined by the priority of a keyword, and a command may be sent.

(3) When the programs overlap, information showing program information on the station which is not currently viewed may be displayed—for example, an indication “Keywords ‘Tokugawa's buried money’ is on the air at ABC.” may be displayed.

It is also preferable that the server is configured to obtain program information from any source other than the broadcast waves. The program information from the broadcast waves may be compact information including, for example, programs for one week. However, it is expected that each broadcast station has more program information including further programs or including, for example, more supporting role information. If a search range on the Internet is expanded, it is likely that information regarding programs in which rising entertainers, for example, participate may be obtained.

The embodiment has the advantage of permitting the simplification of a software configuration of the video receiver because the server side conducts searches. As power-on is not dependent on the video receiver, the television is properly turned on when the time of the program desired by the viewer has been reached even if the television is powered off (inactive) for a long time, that is, even if the television has not acquired program information (EPG) for some time. In some cases, program information can be unnecessary.

According to the present embodiment, the television can be powered on before the broadcast of a program desired by the user, the television can be tuned to the program, and the television can be automatically powered off after the end of the program, without the operation of the television by the user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display apparatus comprising:
a registering module configured to register a keyword;
a sending module configured to send the keyword to a server;
a receiving module configured to receive control information based on the keyword from the server; and
a controller configured to control a turning on power or switching channels or turning off power on the basis of the control information.

2. The video display apparatus of claim 1, wherein power is turned on or channels are switched immediately before an actual broadcast time of a program which matches the keyword.

3. The video display apparatus of claim 1, wherein power is turned off at the end of an actual broadcast time of a program which matches the keyword.

4. A server comprising:
a receiving module configured to receive a keyword from a video display apparatus;
a searching module configured to search for a program corresponding to the keyword;
an extracting module configured to extract a broadcast time of the program; and
a sending module configured to send power-on or channel-switching or power-off control information to the display apparatus in accordance with the broadcast time.

5. The server of claim 4, wherein the power-on or channel-switching or power-off control information is sent immediately before an actual broadcast time of a program corresponding to the keyword.

6. The server of claim 4, wherein the power-off control information is sent at the end of an actual broadcast time of a program corresponding to the keyword.

7. A video display method comprising:
registering a keyword;
sending the keyword to a server;
receiving control information based on the keyword from the server; and
turning on power or switching channels or turning off power on the basis of the control information.

8. The method of claim 7, wherein the power is turned on or channels are switched immediately before an actual broadcast time of a program which matches the keyword.

9. The method of claim 7, wherein the power is turned off at the end of an actual broadcast time of a program which matches the keyword.
